(19) United States
(12) Patent Application Publication
(10) Pub. No.: US 2014/0063506 A1
(43) Pub. Date: Mar. 6, 2014

(54) REAL-TIME, DISPERSION-COMPENSATED LOW-COHERENCE INTERFEROMETRY SYSTEM

(71) Applicants: Jin U. Kang, Ellicott City, MD (US); Kang Zhang, Baltimore, MD (US)

(72) Inventors: Jin U. Kang, Ellicott City, MD (US); Kang Zhang, Baltimore, MD (US)

(73) Assignee: The Johns Hopkins University, Baltimore, MD (US)

(21) Appl. No.: 14/114,678

(22) PCT Filed: May 4, 2012
(86) PCT No.: PCT/US12/36644

§ 371 Date: Oct. 29, 2013

Related U.S. Application Data
(60) Provisional application No. 61/482,293, filed on May 4, 2011.

(51) Int. Cl. G01B 9/02

(52) U.S. Cl. CPC G01B 9/02091
USPC 356/451; 356/479

(57) ABSTRACT

A real-time, dispersion-compensated low coherence interferometric system includes a fiber-optic, a bulk-optic, or a combination of bulk and fiber-optic system comprising a reference path and an observation path; a light source optically coupled to the fiber-optic, bulk-optic, or combination of bulk and fiber-optic system to illuminate the reference and observation paths; an optical detection system arranged to receive combined light returned along the reference and observation paths, the optical detection system providing detection signals; and a data processing system arranged to communicate with the optical detection system to receive the detection signals. The data processing system includes a parallel processor configured to process the detection signals to provide real-time dispersion compensation to numerically compensate for dispersion in the reference path relative to the observation path.

### CROSS-REFERENCE OF RELATED APPLICATION

This application claims priority to U.S. Provisional Application No. 61/482,293 filed May 4, 2011, the entire content of which is hereby incorporated by reference.

This invention was made with Government support of Grant No. R21 1R21NS063131-01A1, awarded by the Department of Health and Human Services, The National Institutes of Health (NIH). The U.S. Government has certain rights in this invention.

### BACKGROUND

1. Field of Invention

The field of the currently claimed embodiments of this invention relates to interferometry systems; and more particularly to real-time, dispersion-compensated low-coherence interferometry based imaging and sensing systems.

2. Discussion of Related Art

Optical coherence tomography (OCT) has been viewed as an “optical analogy” of ultrasound sonogram (US) imaging since its invention in early 1990's (D. Huang, E. A. Swanson, C. P. Lin, J. S. Schuman, W. G. Stinson, W. Chang, M. R. Hee, T. Flotte, K. Gregory, C. A. Puliafito, and J. G. Fujimoto, “Optical coherence tomography,” Science, vol. 254, pp. 1178-1181, 1991). Compared to the conventional image-guided interventions (IGI) using modalities such as magnetic resonance imaging (MRI), X-ray computed tomography (CT) and ultrasound (US) (T. Peters and K. Cleary, Image-Guided Interventions: Technology and Applications, Springer, 2008), OCT has much higher spatial resolution and therefore possesses great potential for applications in a wide range of microsurgeries, such as vitreo-retinal surgery, neurological surgery and otolaryngologic surgery.

As early as the late 1990's, interventional OCT for surgical guidance using time domain OCT (TD-OCT) at a slow imaging speed of hundreds of A-scans/s has been demonstrated (S. A. Boppart, B. E. Bouma, C. Pitris, G. J. Tearney, J. F. Southern, M. E. Brezinski, J. G. Fujimoto, “Intraoperative assessment of microsurgery with three-dimensional optical coherence tomography,” Radiology, vol. 208, pp. 81-86, 1998). Thanks to the technological breakthroughs in Fourier domain OCT (FD-OCT) during the last decade, ultrahigh-speed OCT is now available at >100,000 A-scan/s. For example, see the following:
B. Potsaid, I. Gorczynska, V. J. Srinivasan, Y. Chen, J. Jiang, A. Cable, and J. G. Fujimoto, “Ultrahigh speed Spectral/Fourier domain OCT ophthalmic imaging at 70,000 to 312,500 axial scans per second,” Opt. Express, vol. 16, pp. 15149-15169, 2008.
R. Huber, D. C. Adler, and J. G. Fujimoto, “Buffered Fourier domain mode locking: unidirectional swept laser sources for optical coherence tomography imaging at 370,000 lines/s,” Opt. Lett., vol. 31, pp. 2975-2977, 2006.
W-Y. Oh, B. J. Vakoc, M. Shishkov, G. J. Tearney, and B. E. Bouma, “>400 kHz repetition rate wavelength-swept laser and application to high-speed optical frequency domain imaging,” Opt. Lett., vol. 35, pp. 2919-2921, 2010.
B. Potsaid, B. Baumann, D. Huang, S. Barry, A. E. Cable, J. S. Schuman, J. S. Duker, and J. G. Fujimoto, “Ultrahigh speed 1050 nm swept source/Fourier domain OCT retinal and anterior segment imaging at 100,000 to 400,000 axial scans per second,” Opt. Express, vol. 18, pp. 20029-20048, 2010.
W. Wieser, B. R. Biedermann, T. Klein, C. M. Eigenwillig, and R. Huber, “Multi-Megahertz OCT: High quality 3D imaging at 20 million A-scans and 4.5 GVoxels per second,” Opt. Express, vol. 18, pp. 14685-14704, 2010.
T. Klein, W. Wieser, C. M. Eigenwillig, B. R. Biedermann, and R. Huber, “Megahertz OCT for ultrawide-field retinal imaging with a 1050 nm Fourier domain mode-locked laser,” Opt. Express, vol. 19, pp. 3044-3062, 2011.

For a spectrometer-based SD-OCT, an ultrahigh speed CMOS line scan camera based system has achieved up to 312,500 line/s in 2008 (Potsaid et al.); while for a swept laser type OCT, >20,000,000 line/s rate was achieved by multi-channel FD-OCT using a Fourier Domain Mode Locking (FDML) laser in 2010 (Wieser et al.).

Dispersion compensation is one of the main limiting factors in obtaining ultrahigh-resolution Fourier-domain optical coherence tomography (FD-OCT) imaging. Both hardware and software (numerical) methods have been implemented to overcome this limitation (Wojtkowski, M., Srinivasan, V., Ko, T., Fujimoto, J., Kowalczyk, A., and Duker, J.: ‘Ultrahigh-resolution, high-speed, Fourier domain optical coherence tomography and methods for dispersion compensation’, Opt. Express, 2004, 12, pp. 2404-2422). Compared to hardware methods which involve physically matching the dispersion of the reference and the sample arms, numerical dispersion compensation is more cost-effective and adaptable. However, numerical algorithms that involve Hilbert transforms and phase correction require heavy computational loading and therefore in most cases numerical dispersion compensation has to be performed as a post-processing. Therefore, there remains a need for improved dispersion-compensated interferometry systems.

### SUMMARY

A real-time, dispersion-compensated low coherence interferometric system according to an embodiment of the current invention includes a fiber-optic, a bulk-optic, or a combination of bulk and fiber-optic system comprising a reference path and an observation path; a light source optically coupled to the fiber-optic, bulk-optic, or combination of bulk and fiber-optic system to illuminate the reference and observation paths; an optical detection system arranged to receive combined light returned along the reference and observation paths, the optical detection system providing detection signals; and a data processing system arranged to communicate with the optical detection system to receive the detection signals. The data processing system includes a parallel processor configured to process the detection signals to provide real-time dispersion compensation to numerically compensate for dispersion in the reference path relative to the observation path.

### BRIEF DESCRIPTION OF THE DRAWINGS

Further objectives and advantages will become apparent from a consideration of the description, drawings, and examples.

FIG. 1 is a schematic illustration of a real-time, dispersion-compensated low coherence interferometry based imaging system according to an embodiment of the current invention. In this example, the system configuration is: CCD, CCD line-scan camera; G, grating; L1, L2, L3, L4, L5, achromatic lenses; C, 50:50 broadband fiber coupler; PC, polarization controller; GVS, galvanometer pairs; SL, scanning lens; SP, sample; M, mirror; WCL, water cell.

FIG. 2 is a flowchart illustrating a data processing architecture according to an embodiment of the current invention. It shows standard FD-OCT (routine (A)), and full-range FD-OCT (routine (B)). Dashed arrows correspond to thread triggering; Solid arrows to the main data stream; Hollow arrows to the internal data flow of the GPU. Here the graphics memory refers to global memory.

FIGS. 3A-3C show signal processing results. (a) Benchmark test of processing speeds of different FD-OCT methods with dispersion compensation: LIFFT, standard FD-OCT with linear spline interpolation; LIFFT-C, full-range FD-OCT with linear spline interpolation; CIFFT, standard FD-OCT with cubic spline interpolation; CIFFT-C, full-range FD-OCT with cubic spline interpolation; (b) Profile of an A-scan by CIFFT-C, with a complex-conjugate suppressing ratio of ˜60 dB; (c) Comparison of dispersion compensated and uncompensated point spread function of the system by CIFFT-C.

FIGS. 4A-4D show examples of images of an 8-layer polymer phantom: without (a) and with (b) dispersion compensation. The scale bars indicate 500 μm for both directions and the arrow indicates the zero-delay line position. (c) and (d) magnifies the regions inside the boxes from (a) and (b) respectively.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

The term “light” as used herein is intended to have a broad meaning that can include both visible and non-visible regions of the electromagnetic spectrum. For example, visible, near infrared, infrared and ultraviolet light are all considered as being within the broad definition of the term “light.” The term “real-time” is intended to mean that the OCT images can be provided to the user during use of the OCT system. In other words, any noticeable time delay between detection and image displaying to a user is sufficiently short for the particular application at hand. In some cases, the time delay can be so short as to be unnoticeable by a user.

Since A-scan OCT signals are acquired and processed independently, the reconstruction of an FD-OCT image is inherently ideal for parallel processing methods, such as multi-core CPU parallelization (G. Liu, J. Zhang, L. Yu, T. Xie, and Z. Chen, “Real-time polarization-sensitive optical coherence tomography data processing with parallel computing,” Appl. Opt., vol. 48, pp. 6365-6370, 2009) and FPGA hardware acceleration (T. E. Ustun, N. V. Iftimia, R. D. Ferguson, and D. X. Hammer, “Real-time processing for Fourier domain optical coherence tomography using a field programmable gate array,” Rev. Sci. Instrum., vol. 79, pp. 114301, 2008; A. E. Desjardins, B. J. Vakoc, M. J. Suter, S. H. Yun, G. J. Tearney, B. E. Bouma, “Real-time FPGA processing for high-speed optical frequency domain imaging,” IEEE Trans. Med. Imaging, vol. 28, pp. 1468-1472, 2009). Recently, cutting-edge general purpose computing on graphics processing units (GPGPU) technology has been gradually utilized for ultra-high speed FD-OCT imaging. See, for example:
Y. Watanabe and T. Itagaki, “Real-time display on Fourier domain optical coherence tomography system using a graphics processing unit,” J. Biomed. Opt., vol. 14, pp. 060506, 2009.
K. Zhang and J. U. Kang, “Real-time 4D signal processing and visualization using graphics processing unit on a regular nonlinear-k Fourier-domain OCT system,” Opt. Express, vol. 18, pp. 11772-11784, 2010.
S. V. Jeught, A. Bradu, and A. G. Podoleanu, “Real-time resampling in Fourier domain optical coherence tomography using a graphics processing unit,” J. Biomed. Opt., vol. 15, pp. 030511, 2010.
Y. Watanabe, S. Maeno, K. Aoshima, H. Hasegawa, and H. Koseki, “Real-time processing for full-range Fourier-domain optical-coherence tomography with zero-filling interpolation using multiple graphic processing units,” Appl. Opt., vol. 49, pp. 4756-4762, 2010.
K. Zhang and J. U. Kang, “Graphics processing unit accelerated non-uniform fast Fourier transform for ultrahigh-speed, real-time Fourier-domain OCT,” Opt. Express, 18, pp. 23472-23487, 2010.
K. Zhang and J. U. Kang, “Real-time intraoperative 4D full-range FD-OCT based on the dual graphics processing units architecture for microsurgery guidance,” Biomed. Opt. Express, vol. 2, pp. 764-770, 2011.
J. Rasakanthan, K. Sugden, and P. H. Tomlins, “Processing and rendering of Fourier domain optical coherence tomography images at a line rate over 524 kHz using a graphics processing unit,” J. Biomed. Opt., vol. 16, pp. 020505, 2011.
J. Li, P. Bloch, J. Xu, M. V. Sarunic, and L. Shannon, “Performance and scalability of Fourier domain optical coherence tomography acceleration using graphics processing units,” Appl. Opt., vol. 50, pp. 1832-1838, 2011.
K. Zhang, and J. U. Kang, “Real-time numerical dispersion compensation using graphics processing unit for Fourier-domain optical coherence tomography,” Elect. Lett., vol. 47, pp. 309-310, 2011.

Compared to FPGAs and multi-core processing methods, GPGPU acceleration is more cost-effective in terms of price/performance ratio and convenience of system integration: one or multiple GPUs can be directly integrated into the FD-OCT system in the popular form of a graphics card without requiring any optical modifications. Moreover, as with its original purpose, GPUs are also highly suitable for implementing volume rendering algorithms on reconstructed 3D data sets, which provides a convenient unified solution for both reconstruction and visualization.

As noted in the Background, numerical algorithms that involve Hilbert transform and phase correction require heavy computational loading and therefore in most cases numerical dispersion compensation has to be performed as a post-processing. However, graphics processing units (GPUs) recently enabled high-speed and high-quality real-time interventional FD-OCT imaging as a low-cost massively parallel processor (Zhang, K., and Kang, J.: ‘Real-time 4D signal processing and visualization using graphics processing unit on a regular nonlinear-k Fourier-domain OCT system’, Opt. Express, 2010, 18, pp. 11772-11784; Zhang, K., and Kang, J. : ‘Graphics processing unit accelerated non-uniform fast Fourier transform for ultrahigh-speed, real-time Fourier-domain OCT’, Opt. Express, 2010, 18, pp. 23472-23487). See also, International Application No. PCT/US2011/066603, filed Dec. 21, 201, assigned to the same assignee as the current application, the entire content of which is incorporated herein by reference for all purposes.

Accordingly, some embodiments of the current invention are directed to numerical dispersion compensation for both standard and full-range complex FD-OCT modes on a GPU architecture. Examples below demonstrate real-time ultrahigh-resolution full-range complex-conjugate-free FD-OCT imaging at 68.4 frame/s with frame size of 1024 (lateral)×2048(axial) pixels.

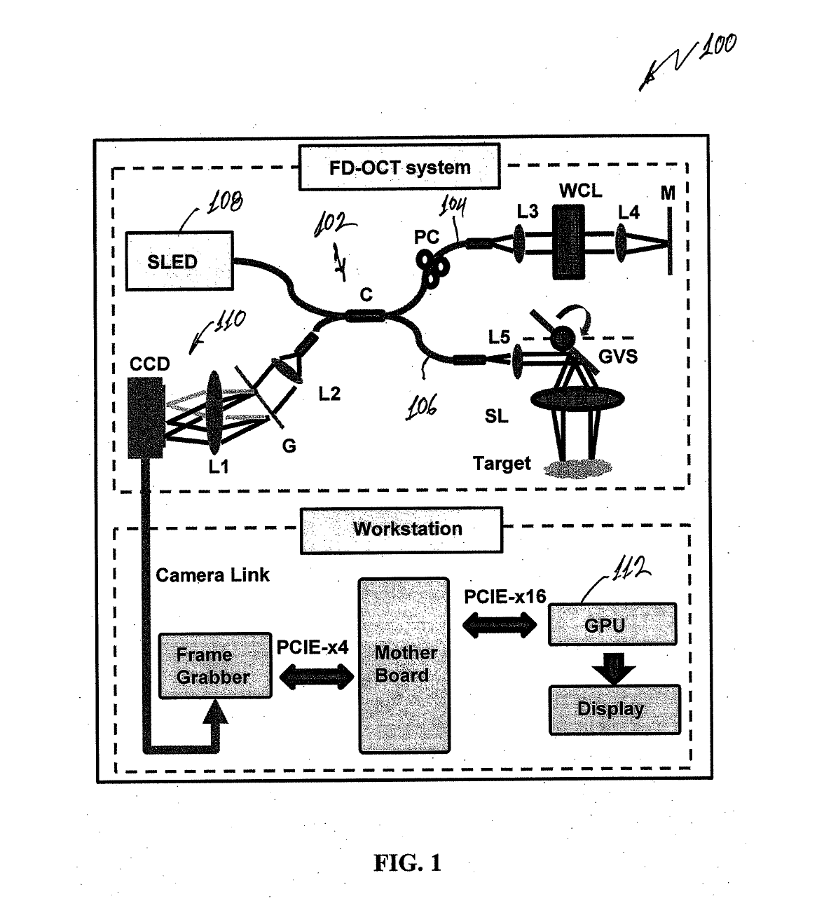

FIG. 1 provides a schematic illustration of a real-time, dispersion-compensated low coherence interferometry based imaging system 100, according to an embodiment of the current invention. The real-time, dispersion-compensated low coherence interferometry based imaging system 100 includes a fiber-optic system 102 that includes a reference path 104 and an observation path 106, a light source 108 optically coupled to the fiber-optic system 102 to illuminate the reference and observation paths (104, 106), and an optical detection system 110 arranged to receive combined light returned along the reference and observation paths (104, 106). The optical detection system 110 provides detection signals. The real-time, dispersion-compensated low coherence interferometry based imaging system 100 also includes a data processing system 112 arranged to communicate with the optical detection system 110 to receive the detection signals. The data processing system 112 at least includes a parallel processor that is configured to process the detection signals to provide real-time dispersion compensation to numerically compensate for dispersion in the reference path 104 relative to the observation path 106.

The parallel processor 112 can be one or more graphics processing unit (GPU) according to an embodiment of the current invention. The optical detection system 110 can include a spectrometer according to an embodiment of the current invention to detect spectral components of light returned from the target.

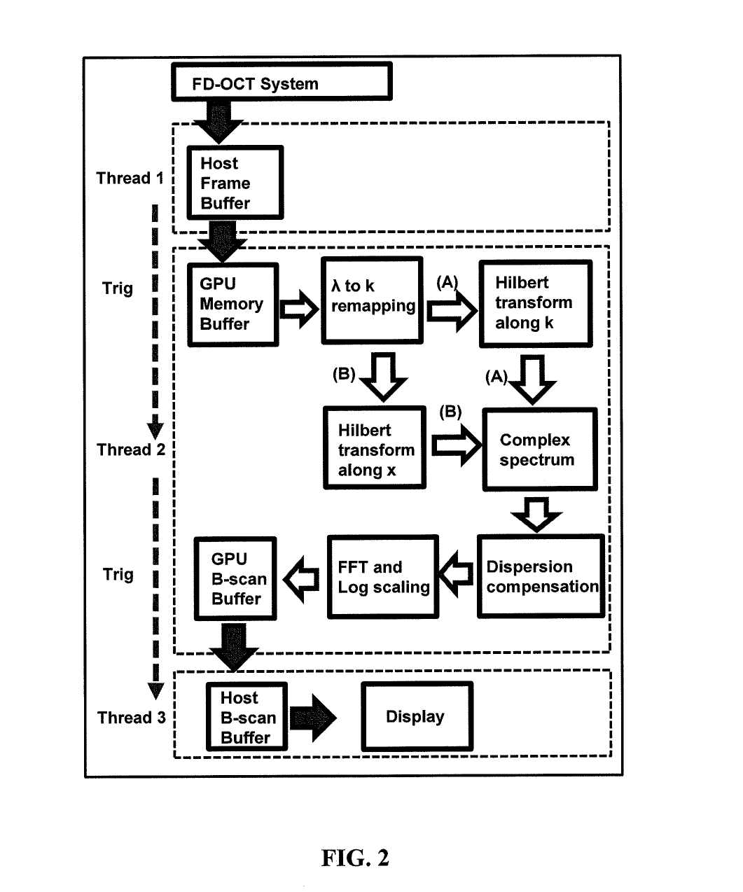

FIG. 2 is a flowchart illustrating a data processing architecture that can be implemented on the parallel processor 112 according to an embodiment of the current invention. In an embodiment, parallel processor 112 is a GPU configured to perform a Hilbert transform on the detection signals. The GPU can be configured to perform full-range Hilbert transforms on the detection signals. The GPU can be further configured to add dispersion compensation to a complex spectrum subsequent to the Hilbert transform to provide a dispersion-compensated spectrum. The GPU can also be configured to perform a Fast Fourier Transform (FFT) on the dispersion-compensated spectrum to provide an output signal.

In one embodiment, the real-time, dispersion-compensated low coherence interferometry based imaging system 100 can be an optical coherence tomography system. In some embodiments, a galvanometer can be arranged to scan light from the observation path 106 of the fiber-optic system 102 across an object being imaged (target). In some embodiments, the data processing system 112 can perform real-time dispersion compensation at least at a speed equal to a frame acquisition speed. In some embodiments, the data processing system can perform dispersion compensation to achieve axial resolution better than 1.5 times an ideal axial resolution.

Some alternative embodiments can include combinations with Non-uniform Fourier transforms to improve the point spread function of FD-OCT. Also, embodiments may be applied to other optical coherence and interferometry based areas involving, for example, broadband light sources and dispersion mismatching, such as in ultrafast optics.

Further additional concepts and embodiments of the current invention will be described by way of the following examples. However, the broad concepts of the current invention are not limited to these particular examples.

### EXAMPLES

FD-OCT experiment: The embodiment of FIG. 1 can include a 12-bit, 70 kHz, 2048 pixel CCD line-scan camera (EM4, e2v, USA), which is used as the detector of the OCT spectrometer in the following example. The superluminescence (SLED) light source has 105 nm effective bandwidth and centered at 845 nm, which gave the theoretical axial resolution of 3.0 μm in air. Here a 2 cm water cell is placed in the reference arm to intentionally unbalance the dispersion of the two arms. To realize the full-range complex OCT mode, a phase modulation is applied to each B-scan's 2D interferogram frame by slightly displacing the probe beam off the first galvanometer's pivoting point (Zhang, K., and Kang, J.: ‘Graphics processing unit accelerated non-uniform fast Fourier transform for ultrahigh-speed, real-time Fourier-domain OCT’, Opt. Express, 2010, 18, pp. 23472-23487). A quad-core Dell T7500 workstation was used to host a frame grabber (PCIE-x4 interface), and an NVIDIA GeForce GTX 580 GPU (PCIE-x16 interface, 512 cores at 1.59 GHz, 1.5 GB graphics memory). FIG. 2 shows the data processing flowchart of the system, where routine (A) indicates standard FD-OCT and routine (B) for full-range complex FD-OCT. The dispersion compensation is realized by adding a phase correction term Φ̅=−α₂(ω−ω₀)²−α₃(ω−ω₀)³ to the complex spectrum after the Hilbert transform, where α₂=2.2×10⁻⁵ and a₃=−1.8×10⁻¹⁰ are pre-optimized values according to the system properties (Wojtkowski, M., Srinivasan, V., Ko, T., Fujimoto, J., Kowalczyk, A., and Duker, J.: ‘Ultrahigh-resolution, high-speed, Fourier domain optical coherence tomography and methods for dispersion compensation’, Opt. Express, 2004, 12, pp. 2404-2422). These values are stored in the graphics memory and can also be obtained in real time (Liu, X., Balicki, M., Taylor, R., and Kang, J.: ‘Towards automatic calibration of Fourier-Domain OCT for robot-assisted vitreoretinal surgery’, Opt. Express, 2010, 18, pp. 24331-24343).

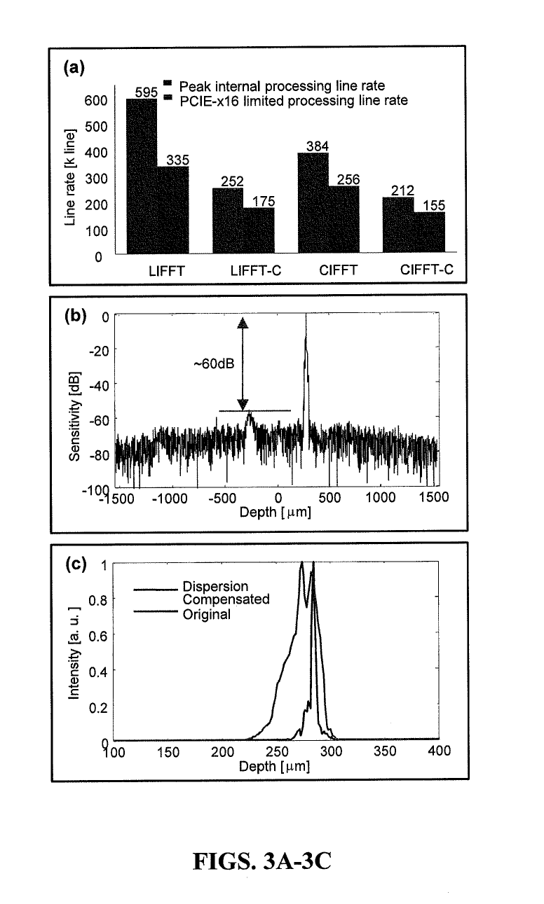

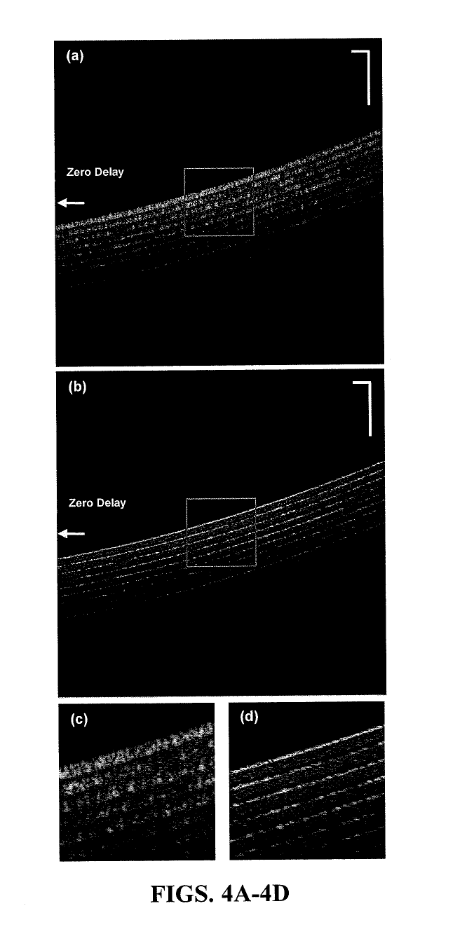

Results and discussion: First, we performed the processing speed benchmark test of different FD-OCT methods with dispersion compensation, where a 1024 A-scan image of a mirror is used. As shown in FIG. 3A, the PCIE-x16 bandwidth limited line rate using cubic spline interpolation was 155 k line/s, which is still more than twice the camera acquisition rate. FIG. 3B shows the profile of a single A-scan by CIFFT-C mode, achieving a complex-conjugate artifact suppressing ratio of ˜60 dB. FIG. 3C presents the comparison between the dispersion compensated and uncompensated point spread functions of the system by CIFFT-C, indicating the FWHM of 3.5 μm versus 30 μm. Then an 8-layer polymer phantom was used to perform real-time imaging using CIFFT-C mode, at 68.4 frame/s with 1024 (lateral)×2048(axial) pixels (rescaled to 1024×1024 for screen display), which corresponds to the full camera speed of 70 k line/s. The screen captured images are shown in FIGS. 4A-4D. The original image FIG. 4A shows serious deterioration due to the huge dispersion mismatch induced by the water cell in the reference arm, while FIG. 4B shows a clear high-resolution image when the numerical compensation was enabled.

Conclusion: In this example, we demonstrated a numerical dispersion compensation technique for real-time FD-OCT using a GPU architecture. This embodiment is highly cost effective and can be generally applied to other FD-OCT systems without any optical modifications.

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. A real-time, dispersion-compensated low coherence interferometric system, comprising:
a fiber-optic, a bulk-optic, or a combination of bulk and fiber-optic system comprising a reference path and an observation path;
a light source optically coupled to said fiber-optic, bulk-optic, or combination of bulk and fiber-optic system to illuminate said reference and observation paths;
an optical detection system arranged to receive combined light returned along said reference and observation paths, said optical detection system providing detection signals; and
a data processing system arranged to communicate with said optical detection system to receive said detection signals,
wherein said data processing system comprises a parallel processor configured to process said detection signals to provide real-time dispersion compensation to numerically compensate for dispersion in said reference path relative to said observation path.

2. A real-time, dispersion-compensated low coherence interferometric system according to claim 1, wherein said parallel processor is a graphics processing unit (GPU).

3. A real-time, dispersion-compensated low coherence interferometric system according to claim 2, wherein said optical detection system comprises a spectrometer to detect spectral components of light returned from said target.

4. A real-time, dispersion-compensated low coherence interferometric system according to claim 3, wherein said GPU is configured to perform a Hilbert transform on said detection signals.

5. A real-time, dispersion-compensated low coherence interferometric system according to claim 3, wherein said GPU is configured to perform full-range Hilbert transforms on said detection signals.

6. A real-time, dispersion-compensated low coherence interferometric system according to claim 4, wherein said GPU is configured to add dispersion compensation to a complex spectrum subsequent to said Hilbert transform to provide a dispersion-compensated spectrum.

7. A real-time, dispersion-compensated low coherence interferometric system according to claim 6, wherein said GPU is configured to perform a Fast Fourier Transform (FFT) on said dispersion-compensated spectrum to provide an output signal.

8. A real-time, dispersion-compensated low coherence interferometric system according to claim 1, wherein said real-time, dispersion-compensated low coherence interferometric system is an optical coherence tomography system.

9. A real-time, dispersion-compensated low coherence interferometric system according to claim 8, further comprising an optical scanner to scan light from said observation path across an object being imaged.

10. A real-time, dispersion-compensated low coherence interferometric system according to claim 9, wherein said data processing system performs real-time dispersion compensation at least at a speed equal to a frame acquisition speed.

11. A real-time, dispersion-compensated low coherence interferometric system according to claim 1, wherein said data processing system performs dispersion compensation to achieve axial resolution better than 1.5 times an ideal axial resolution.
